(19) United States
(12) Patent Application Publication
(10) Pub. No.: US 2018/0011523 A1
(43) Pub. Date: Jan. 11, 2018

(54) POWER ADAPTER WITH I/O PORTS

(71) Applicant: Hewlett-Packard Development Company, L.P., Houston, TX (US)

(72) Inventors: Leslie Behrend, Houston, TX (US); Ligy Kurian, Houston, TX (US); Stephen Waybright, Conroe, TX (US)

(21) Appl. No.: 15/206,098

(22) Filed: Jul. 8, 2016

(51) Int. Cl. G06F 1/26

(52) U.S. Cl. CPC G06F 1/266; G06F 1/263

(57) ABSTRACT

A power adapter for a computing device includes a housing, first and second physical connections, a power transformer, one or more input/output (I/O) ports, and a data connection. The first physical connection is exposed at the housing to connect to the computing device to provide device power to the computing device. The second physical connection is exposed at the housing to connect to an alternating current (AC) mains power source to receive AC mains power, without an intermediary power transformer between the AC mains power source and the power adapter. The power transformer is disposed within the housing to convert the AC power to the device power. The I/O ports exposed at the housing to connect to peripheral devices. The data connection is to communicatively connect the peripheral devices to the computing device.

### BACKGROUND

Many types of electronic devices, such as laptop and notebook computing devices, connect to wall outlets and other sources of alternating current (AC) mains power via external AC power adapters. One end of a power adapter connects to an AC mains power source, and the other end of the power adapter connects to an electronic device. The power adapter converts the AC mains power that an AC mains power source provides, such as nominally 120 or 220-230 volts, to the device power that the electronic device uses, which may be between 5-48 volts of alternating current or direct current (DC). Power adapters are generally rated by amps and/or watts, with larger electronic devices typically needing more amperage and/or wattage than smaller devices. The size and/or weight of a power adapter is usually dependent on the amount of power that the adapter can provide.

### BRIEF DESCRIPTION OF THE DRAWINGS

FIG. 1 is a diagram of an example power adapter for a computing device.

FIG. 2 is a block diagram of an example power adapter for a computing device.

FIGS. 3A, 3B, and 3C are each a diagram of a portion of an example power adapter for a computing device.

FIG. 4 is a diagram of a portion of an example power adapter for a computing device.

FIG. 5 is a diagram of an example system including a power adapter, a computing device, and peripheral devices.

FIG. 6 is a flowchart of an example method for using a power adapter with a computing device.

### DETAILED DESCRIPTION

As noted in the background, laptop and notebook computing devices, as well as other types of electronic devices, commonly connect to sources of alternating current (AC) power using external power adapters, which convert AC power to device power for the devices. While laptop computing devices in particular have markedly decreased in size, including thickness, their power adapters have not to the same extent, since they include power transformers that generally are of a minimum size to properly convert AC power to device power. As such, users tend to view power adapters as a necessary evil that have to be carried around with portable computing devices to ensure that they can recharge the devices' batteries, and so on.

Disclosed herein are techniques for improving the usefulness of power adapters, so that users of computing devices that require such adapters obtain added benefit when lugging the adapters along with their devices. Specifically, disclosed herein are power adapters that add docking station functionality to the power conversion capabilities of the power adapters. As such, the power adapters permit peripheral devices, including display devices, network devices, and other devices like printing devices and input devices, among other types of devices, to be communicatively connected to the computing devices via their power adapters.

The novel power adapters described herein also ameliorate the need for users to have to carry separate docking stations for their computing devices, which themselves may require external power adapters. A power adapter that has a number of input/output (I/O) ports by which to indirectly connect peripheral devices to a computing device can further mitigate the need for the computing device itself to have as many I/O ports as may otherwise be necessary. For instance, a manufacturer may reduce the number of I/O ports on a computing device to the minimum that is likely to be used when the device is being powered from its internal battery, and instead relegate the I/O ports that will be used when the computing device is in a less-mobile situation to the power adapter. As such, the computing device can be made even thinner and lighter, because many I/O ports may be moved to the device's power adapter.

As used herein, AC mains power is the AC power that is available at a wall outlet in a building like a home or business. In some parts of the world, AC mains power is nominally 120 volts at 60 hertz, and is also considered to be 110 or 115 volts. In other parts of the world, AC mains power is nominally 220-230 volts at 50 hertz, and is also considered to be 208-240 volts. AC mains power is also referred to as household power, household electricity, house current, powerline power, domestic power, wall power, line power, city power, street power, and grid power.

An AC mains power source can be a wall outlet to which a power adapter plugs into, or a device such as an uninterruptible power supply (UPS), a surge protector, and/or a line conditioner, to which the power adapter can be directly connected as well. Between the AC mains power source and the power adapter there is no intermediary transformer. That is, the power adapter is the mechanism by which AC mains power is stepped down to a lower AC voltage, when the computing device powered through the power adapter uses AC power, or by which AC mains power is stepped down and converted to a lower direct current (DC) voltage, when the computing device uses DC power. As used herein, conversion of AC mains power to device power encompasses both just stepping down AC mains power to a lower AC voltage as well as stepping down and converting AC mains power to a lower DC voltage.

As used herein, then, device power is the AC or DC power that the computing device directly receives from the power adapter, and that the computing device uses to operate, to charge any internal batteries, and so on. The device power is of lower voltage than the AC mains power, or otherwise the power adapter would typically be unnecessary. The device power may be between 5-48 volts of either AC or DC. The power adapter itself may include a transformer that is rated to provide a designated voltage of AC or DC device power at no more than a specified number of amps. The transformer, however, may be a switching transformer that is able to receive a range of AC mains power, such as between 100-240 volts at 50-60 hertz.

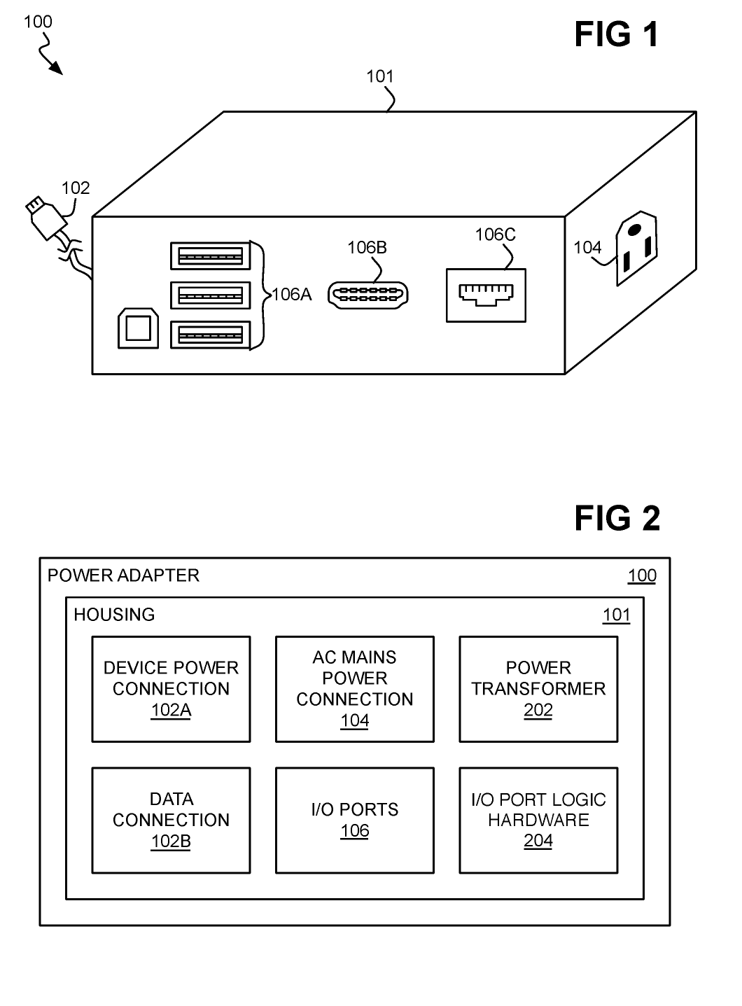

FIG. 1 shows an example power adapter 100 for a computing device like a laptop or notebook computing device. The power adapter 100 includes a housing 101, and a physical connection 102 exposed at the housing 101 to connect the power adapter 100 to the computing device to provide device power to the computing device. In the example of FIG. 1, the physical connection 102 is a universal serial bus type C (USB-C) cable; that is, a USB-C cable that terminates at a USB-C connector that is inserted into a corresponding USB-C port of the computing device. The physical connection 102 is thus a device power connection. In the example of FIG. 1, then, the physical connection 102 is a cable hardwired to the power adapter 100 through the housing 101.

The power adapter 100 includes another physical connection 104 exposed at the housing 101 to connect to an AC mains power source to receive AC mains power from the AC mains power source, without an intermediary power transformed between the source and the adapter 100. In the example of FIG. 1, the physical connection 104 is a power port into which a power plug at an end of a power cable is connected. The other end of the power cable has a power plug that inserted into a corresponding power port of an AC mains power source. The physical connection 104 is thus an AC mains power connection. For example, the physical connection 104 may be a National Electrical Manufacturers Association (NEMA) 5-15-R, 1-15-R, IEC 320 C13, IEC 320 C5, IEC 320 C7, IEC 320 C7, CEE 7/7, or another type of power port into which a corresponding compatible power plug of a power plug is inserted. The power plug at the other end of the power cable that is inserted into a corresponding power port of an AC mains power source may be a NEMA 5-15-P, NEMA 1-15-P, or another type of power plug. In the example of FIG. 1, then, the physical connection 102 is a port to which a connector at one end of an external power cable connects, where the cable has a connector at the other end to connect to an AC mains power source.

The power adapter 100 includes input/output (I/O) ports 106A, 106B, and 106C, collectively referred to as the ports 106, exposed at the housing 101 to connect to peripheral devices. The I/O ports 106A can include USB type A and USB type B ports, compatible with the USB 1.1, 2.0, and/or 3.0 specification, for instance, and/or other types of serial ports. The I/O port 106B is a display port to connect to a display device, and may be a high-definition multimedia interface (HDMI) port, a Thunderbolt port, a DisplayPort (DP) port, a mini-DP port, a digital visual interface (DVI) port, a video graphics array (VGA) port, or another type of display port. The I/O port 106C is a network port, such as an RJ45 network port, to connect to a network device, such as via an Ethernet cable.

In the example of FIG. 1, the physical connection 102 is both a device power connection to provide device power to the computing device, and is also a data connection to communicatively connect the peripheral devices directly connected to the I/O ports 106 to the computing device. For instance, a USB-C connection permits both power and data to be sent from the power adapter 100 to the computing device, and data to be sent back from the computing device to the power adapter 100. Therefore, in the example of FIG. 1, there is a single, or sole, physical connection between the power adapter 100 and the computing device, within which the data connection and the device power connection are integrated. The power adapter 100 provides power to the computing device over this single physical connection, and the peripheral devices connected to the I/O ports 106 are communicatively connected to the computing device over this single physical connection.

The computing device thus does not have to be not directly communicatively connected to any of the peripheral devices connected to the I/O ports 106. That is, there does not have to be a cable having one end that is directly connected to the computing device and another end that is directly connected to a peripheral device. Rather, the computing device is indirectly communicatively connected to the peripheral devices through and via the power adapter 100. The power adapter 100 thus can act or serve as a docking station for the computing device. The peripheral devices can remain connected to the I/O ports 106 of the power adapter 100, even as the computing device is periodically connected to and disconnected from the power adapter 100 via the physical connection 102. As such, when the computing device is to receive device power for recharging its internal battery or otherwise, the computing device is connected to the physical connection 102 of the power adapter 100, over which it receives power and also becomes communicatively connected to the peripheral devices.

Stated another way, the computing device may further not be connected to any power adapter other than the power adapter 100. The power adapter 100 thus can be a sole mechanism by which the computing device receives device power for recharging its internal battery or otherwise. Furthermore, in addition to being the (sole) mechanism by which the computing device receives device power, the power adapter 100 provides docking station capability, permitting the computing device to communicatively connect to the peripheral devices directly physically connected to the I/O ports 106.

FIG. 2 shows a block diagram of the example power adapter 100. Exposed at or within the housing 101 is a device power connection 102A and a data connection 1026. In the example of FIG. 1, the connections 102A and 102B are integrated within a single physical connection 102, as described above. The AC mains power connection 104 (i.e., another, separate physical connection) and the I/O ports 106 are also exposed at the housing 101, as described above.

The power adapter 100 includes within the housing 101 a power transformer 202 and I/O port logic hardware 204. The power transformer 202 converts the AC mains power received at the AC mains power source via the AC mains power connection 104 to the device power provided to the computing device at the device power connection 102A. The power transformer 202 can be an AC-to-AC power transformer or an AC-to-DC power transformer. Besides providing device power to the computing device via the device power connection 102A, the power transformer 202 also provides power to the I/O port logic hardware 204.

The I/O port logic hardware 204 includes hardware components so that the computing device can communicatively connect with the peripheral devices directly connected to the I/O ports 106. Such hardware components can include a logic board populated with semiconductor integrated circuits (ICs). Examples of semiconductor ICs include Ethernet controllers, USB controllers, Thunderbolt port controllers, and display controllers. The I/O port logic hardware 204 therefore provides the power adapter 100 with docking station capability at the I/O ports 106.

As noted above, the I/O port logic hardware 204 is powered by the same power transformer 202 that provides the device power to the computing device over the device power connection 102A. As such, no separate power adapter to provide power for the docking station capability of the power adapter 100 may have to be necessary. A user using the power adapter 100 to power a computing device and also as a docking station therefore can foreseeably replace three discrete hardware components with the power adapter 100: a power adapter for the computing device; a separate docking station; and a power adapter for the docking station.

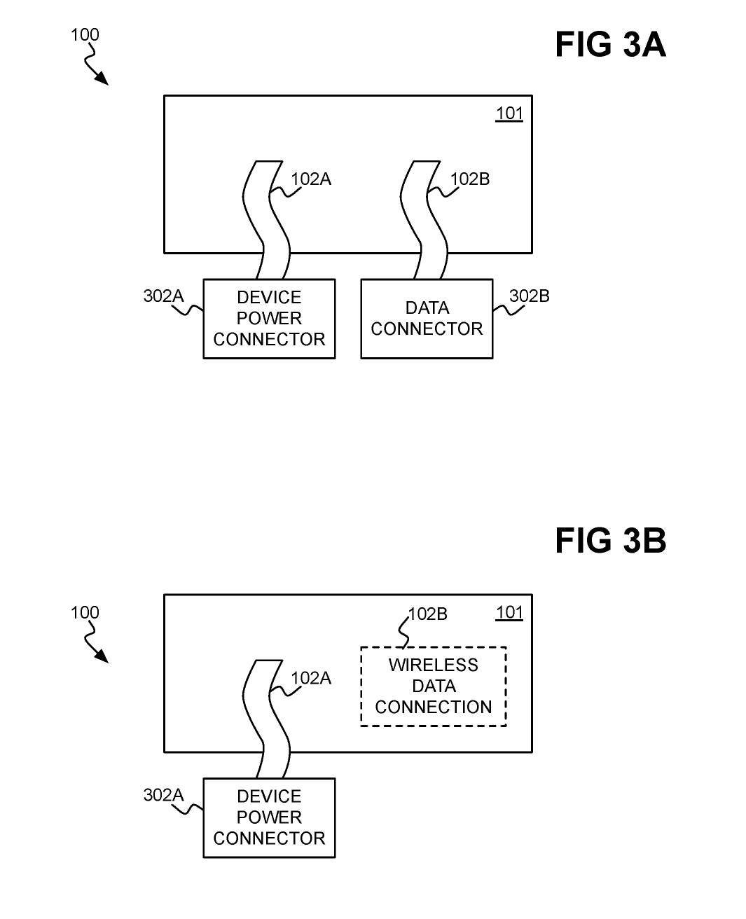

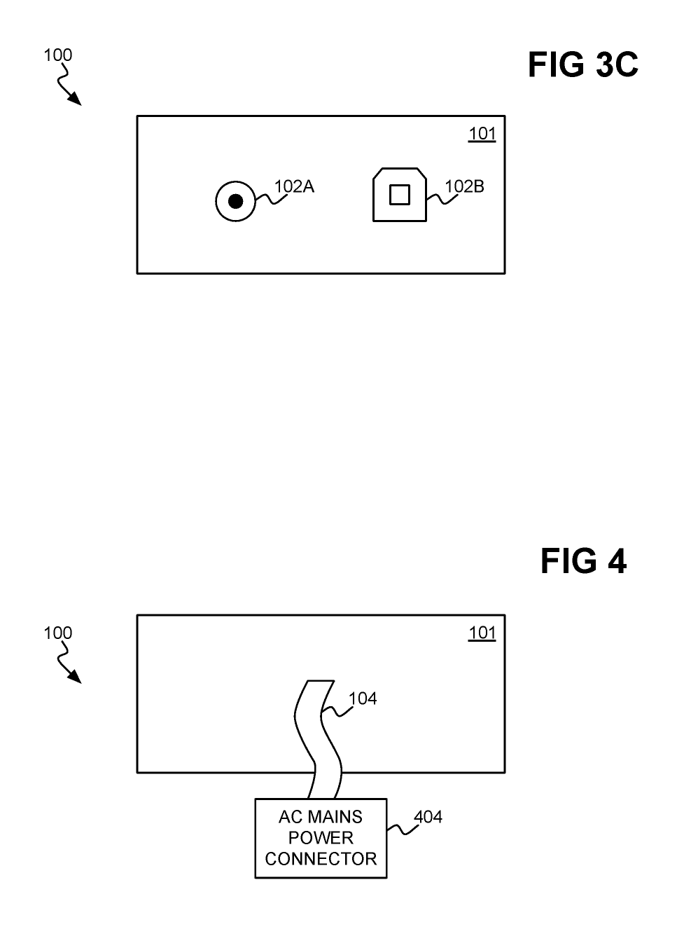

FIGS. 3A, 3B, and 3C show different examples of the device power connection 102A and the data connection 102B that can be used in lieu of the integrated physical connection 102 of FIG. 1. In FIG. 3A, the device power connection 102A is a cable hardwired through the housing 101 and terminating at a device power connector 302A. Examples of such device power connectors 302A include a USB-C power connector, and different types of coaxial or “barrel” power connectors. The power adapter 100 provides just device power to the computing device over the device power connection 102A in the example of FIG. 3A, and does not communicate data over the device power connection 102A.

In FIG. 3A, the data connection 102B is a cable hardwired through the housing 101 and terminating at a data connector 302B. Examples of such data connectors 302B include USB connectors, Thunderbolt connectors, and other types of connectors. The power adapter 100 just communicatively connects the peripheral devices directly physically connected to the I/O ports 106 to the computing device over the data connection 102B in the example of FIG. 3A, and does not provide device power over the data connection 102B. As such, in the example of FIG. 3A, the data connection 102B is a separate physical connection from the physical connection that is the device power connection 102A, so that there are two physical connections between the power adapter 100 and the computing device. The device power connection 102A and the data connection 102B may be the only two physical connections between the power adapter 100 and the computing device.

In FIG. 3B, the device power connection 102A is the same as in FIG. 3A, but the data connection 102B is a wireless connection between the power adapter 100 and the computing device. The wireless connection may be a near-field communication (NFC) wireless connection, a Bluetooth wireless connection, a Wi-Fi wireless connection, or another type of wireless connection. The I/O port logic hardware 204 thus can include in the example of FIG. 3B a wireless controller, including an internal or external, permanently or removably attached antenna. In the example of FIG. 3B, the data connection 102B is a separate connection from the physical connection that is the device power connection 102A, but there may be just one physical connection between the power adapter 100 and the computing device, the device power connection 102A. However, this sole physical connection provides just device power to the computing device, whereas the data connection 102B is a wireless connection.

In FIG. 3C, the device power connection 102A and the data connection 102B are separate physical connections as in FIG. 3A. However, rather than being hardwired cables extending through the housing 101, the connections 102A and 102B are ports in the example of FIG. 3C. Each port is receptive to a connector at an end of an external cable, the other end of which can connect to a port of the computing device. Examples of power ports that can implement the device power connection 102A include a USB-C power port and different types of coaxial or “barrel” power ports. Examples of data ports that can implement the data connection 102B include USB ports, Thunderbolt ports, and other types of ports.

Each of the examples of FIGS. 1, 3A, 3B, and 3C can be modified pursuant to the other examples. For instance, the physical connection 102 in FIG. 1 that integrates both the device power connection 102A and the data connection 102B can be a port exposed at the housing 101 instead of a hardwired cable through the housing 101 as depicted in FIG. 1. The device power connection 102A in FIG. 3A can be a port exposed at the housing 101 as in FIG. 3C instead of a hardwired cable through the housing 101 as depicted in FIG. 3A, while the data connection 102B remains a hardwired cable. The data connection 102B in FIG. 3A can be a port exposed at the housing as in FIG. 3C instead of a hardwired cable through the housing 101 as depicted in FIG. 3A, while the device power connection 102A remains a hardware connection. The device power connection 102A in FIG. 3B can be a port exposed at the housing 101 as in FIG. 3C instead of a hardwired cable through the housing 101 as depicted in FIG. 3B.

FIG. 4 shows a different example of the AC mains power connection 104 that can be used in lieu of that of FIG. 1. In FIG. 4, the AC mains power connection 104 is a cable hardwired through the housing 101 and terminating at an AC mains power connector 404, instead of being a power port as in FIG. 1. The AC mains power connector 404 can be a power plug, such as a NEMA 5-15-P, NEMA 1-15-P, or another type of power plug.

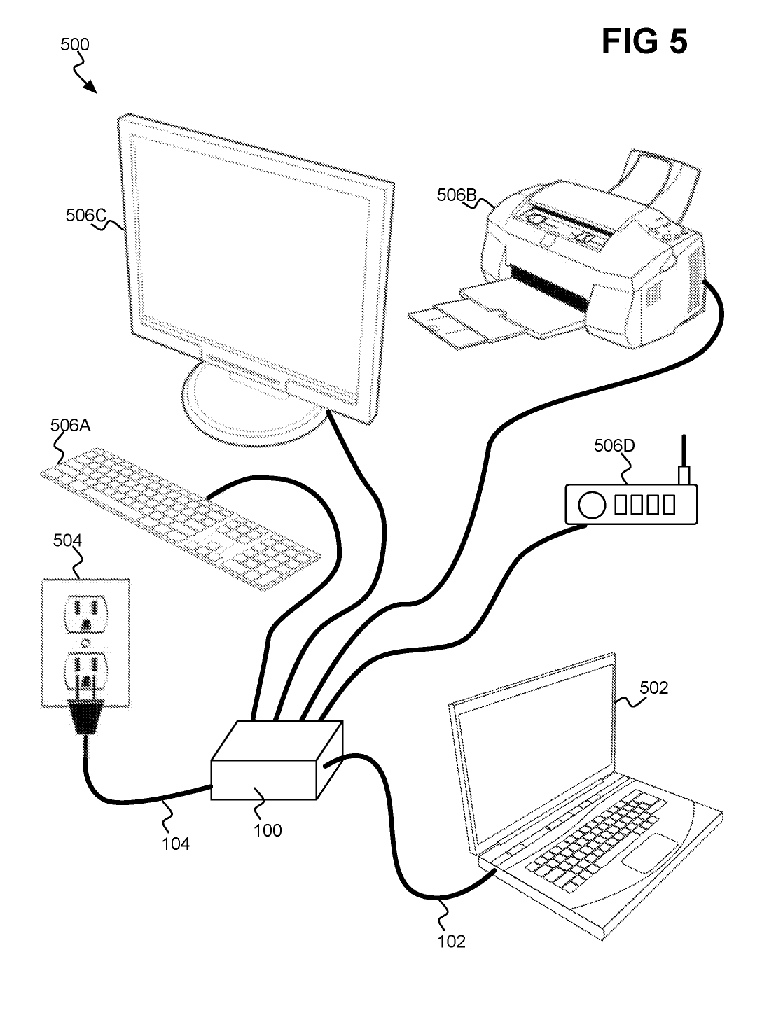

FIG. 5 shows an example system 500. The system 500 includes the power adapter 100 having the physical connection 102 of FIG. 1 to a computing device 502, specifically a laptop or notebook computer. The physical connection 102 in the example of FIG. 5 is a sole physical connection, such as a USB-C cable. The power adapter 100 further has the AC mains power connection 104 to AC mains power 504, which is a wall outlet in the example of FIG. 5. The AC mains power connection 104 in the example of FIG. 5 is a power cable.

The power adapter in FIG. 5 is directly physically connected to peripheral devices 506A, 506B, 506C, and 506D, which are collectively referred to as the peripheral devices 506. The peripheral devices 506 are connected to the I/O ports 106 of FIG. 1. Examples of the peripheral devices 506 include a keyboard, a printing device, a display device, and a network device like a router.

In the example of FIG. 5, the computing device 502 is not connected to the AC mains power 504 except through the power adapter 100. Likewise, the computing device 502 is not connected to any peripheral device 506 except through the power adapter 100. The power adapter 100 thus both serves to provide device power to the computing device 502 and acts as a docking station for the computing device 502 in relation to the peripheral devices 506. A separate docking station, which may have to have a separate power adapter, is thus unnecessary in the example of FIG. 5.

In the example of FIG. 5, any power cables between the AC mains power 504 and the peripheral devices 506 are not depicted, however. For instance, peripheral devices such as printing devices, display devices, and network devices may have separate power connections to the AC mains power, which may include their own power adapters. Other peripheral devices, such as keyboards and other input devices like pointing devices, such as computer mice and touchpads, may not require power, however, and instead be powered from their direct connection to the power adapter 100. These types of peripheral devices may be known as bus-powered devices, in that they are powered on the same data bus, such as a USB data bus, over which they communicate data with the power adapter 100.

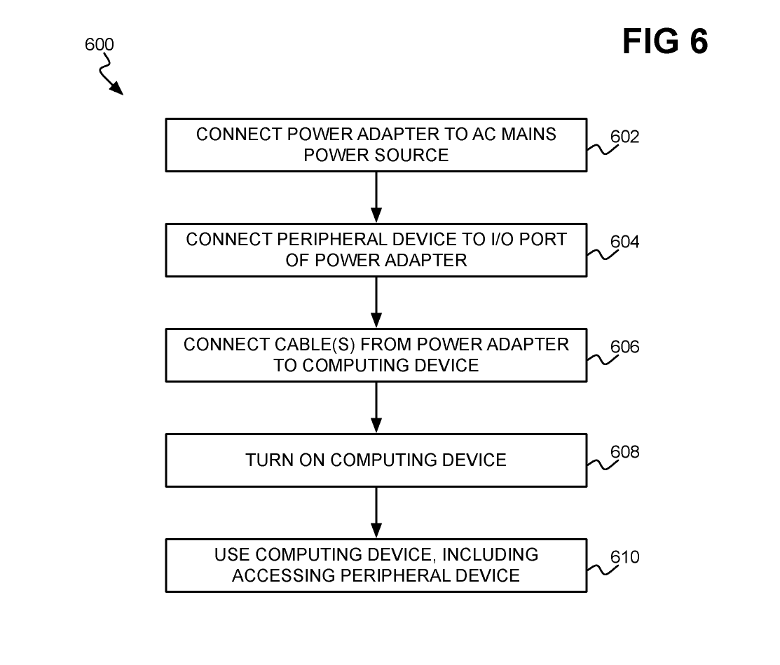

FIG. 6 shows an example method of use 600. The power adapter 100 is connected to the AC mains power source 504 (602), without any intermediary power transformer between the AC mains power source 504 and the power adapter 100. That is, the power that the power adapter 100 receives to convert to device power for the computing device 502 is AC mains power. No intermediary power transformer (i.e., no intermediary power adapter) converts the AC mains power to a different voltage level and/or to DC before the power adapter 100 receives the AC mains power for conversion to device power.

One or more peripheral devices 506 are connected to the I/O ports 106 of the power adapter 100 (604), such as via corresponding cables. One or more cables are connected from the power adapter 100 to the computing device 102 (606) as well. Just one cable may be connected as has been described in the examples of FIGS. 1 and 3A, or just two cables as has been described in the examples of FIGS. 3A and 3C.

The computing device 502 is turned on (608). The computing device 502 receives device power from the power adapter 100. The computing device 502 can then be used (610). Usage of the computing device 502 includes accessing the peripheral devices 506 connected to the power adapter 100 through the data connection 1026 between the power adapter 100 and the computing device 502.

For example, the computing device can receive user input from an input device like a keyboard or a pointing device connected to the power adapter 100 as if the input device were directly connected to the computing device 502. The computing device 502 can connect to a network through a network device connected to the power adapter 100 as if the network device were directly connected to the computing device 502. The computing device 502 can display data on a display device connected to the power adapter 100 as if the display device were directly connected to the computing device 502. The computing device 502 can print data using a printing device connected to the power adapter 100 as if the printing device were directly connected to the computing device 502.

Techniques disclosed herein thus render portable computing devices like laptop and notebook computers even more portable. For instance, rather than having to carry along with a computing device a power adapter for the computing device, a docking station, and possibly a separate power adapter for the docking station, a user just has to carry a power adapter with the computing device. The power device permits the computing device to be connected to AC mains power, while also acting as a docking station for the computing device, by which the user can access on the computing device any peripheral devices directly physically connected to the power adapter.

We claim:

1. A power adapter for a computing device, comprising:
a housing;
a first physical connection exposed at the housing to connect to the computing device to provide device power to the computing device;
a second physical connection exposed at the housing to connect to an alternating current (AC) mains power source to receive AC mains power without an intermediary power transformer between the AC mains power source and the power adapter;
a power transformer disposed within the housing to convert the AC mains power to the device power;
one or more input/output (I/O) ports exposed at the housing to connect to peripheral devices; and
a data connection to communicatively connect the peripheral devices to the computing device.

2. The power adapter of claim 1, wherein the data connection is integrated with the first physical connection as a single physical connection between the power adapter and the computing device over which the device power is provided to the computing device and over which the peripheral devices are communicatively connected to the computing device.

3. The power adapter of claim 1, wherein the data connection is a separate physical connection from the first physical connection, so that there are two physical connections between the power adapter and the computing device.

4. The power adapter of claim 1, wherein the data connection is a wireless connection between the power adapter and the computing device.

5. The power adapter of claim 1, wherein each of the first physical connection and the second physical connection is one of:
a cable hardwired to the power adapter through the housing, the cable terminating at a connector to connect to a corresponding port of the computing device;
a port to which a first connector of an external cable is to connect, a second connector of the external cable to connect to a port of the computing device.

6. The power adapter of claim 1, wherein the I/O ports comprise one or more of:
a display port to connect to a display device as one of the peripheral devices;
a serial port to connect to one of the peripheral devices;
a network port to connect to a network device as one of the peripheral devices.

7. The power adapter of claim 1, wherein the AC mains power has a higher voltage than the device power.

8. The power adapter of claim 1, wherein the device power is one of AC power and DC power.

9. A system comprising:
a computing device;
a power adapter to convert alternating current (AC) mains power from an AC mains power source, to which the power adapter is connectable without an intermediary power transformer between the AC mains power source and the power adapter, to device power to power the computing device;
a physical connection between the computing device and the power adapter over which the power adapter provides the device power to the computing device;
one or more I/O ports at the power adapter to connect to peripheral devices; and
a data connection to communicatively connect the peripheral devices to the computing device.

10. The system of claim 9, wherein the data connection is integrated with the physical connection as a sole physical connection between the power adapter and the computing device over which the device power is provided to the computing device and over which the peripheral devices are communicatively connected to the computing device.

11. The system of claim 9, wherein the data connection is a separate physical connection from the physical connection over which the power adapter provides the device power to the computing device, so that there are just two physical connections between the power adapter and the computing device.

12. The system of claim 9, wherein the physical connection is a sole physical connection between the power adapter and the computing device, and the data connection is a wireless connection between the power adapter and the computing device.

13. The system of claim 9, wherein the physical connection is a first physical connection, and the system further comprises:
a second physical connection between the power adapter and the AC mains power source,
wherein each of the first physical connection and the second physical connection is one of:
a cable hardwired to the power adapter, the cable terminating at a connector to connect to a corresponding port of the computing device;
a port to which a first connector of an external cable is to connect, a second connector of the external cable to connect to a port of the computing device.

14. The system of claim 9, wherein the I/O ports comprise one or more of:
a display port to connect to a display device as one of the peripheral devices;
a serial port to connect to one of the peripheral devices;
a network port to connect to a network device as one of the peripheral devices.

15. The system of claim 9, wherein the computing device is not directly communicatively connected to the peripheral devices, and the computing device is indirectly communicatively connected to the peripheral devices through the power adapter.

16. A method comprising:
connecting a power adapter to an alternating current (AC) mains power source without an intermediary power transformer between the AC mains power source and the power adapter;
connecting a peripheral device to an input/output (I/O) port of the power adapter;
connecting a cable from the power adapter to a computing device;
turning on the computing device, the power adapter converting AC mains power from the AC mains power source to device power, the computing device receiving the device power from the power adapter; and
using the computing device, including accessing the peripheral device at the computing device via a data connection communicatively connecting the peripheral device from the power adapter to the computing device.

17. The method of claim 16, wherein the cable is a sole physical connection between the power adapter to the computing device, the data connection integrated within the sole physical connection.

18. The method of claim 16, wherein the cable is a sole physical connection between the power adapter to the computing device, the data connection being a wireless connection between the power adapter and the computing device.

19. The method of claim 16, wherein the cable is a first cable from the power adapter to the computing device, and the method further comprises:
connecting a second cable from the power adapter to the computing device, the second cable realizing the data connection communicatively connecting the peripheral device from the power adapter to the computing device.

20. The method of claim 16, wherein the computing device is not directly communicatively connected to the peripheral devices, and the computing device is indirectly communicatively connected to the peripheral devices through the power adapter.
